(19) United States
(12) Patent Application Publication
(10) Pub. No.: US 2024/0076504 A1
(43) Pub. Date: Mar. 7, 2024

(54) Color Coatings

(71) Applicant: Apple Inc., Cupertino, CA (US)

(72) Inventors: Lijie Bao, Saratoga, CA (US); Brian S. Tryon, Redwood City, CA (US); Jozef M. Matlak, San Francisco, CA (US); Shinjita Acharya, Santa Clara, CA (US)

(21) Appl. No.: 18/364,760

(22) Filed: Aug. 3, 2023

Related U.S. Application Data
(60) Provisional application No. 63/403,499, filed on Sep. 2, 2022.

(51) Int. Cl. C09D 1/00; C09D 5/33

(52) U.S. Cl. CPC C09D 1/00; C09D 5/004

(57) ABSTRACT

An electronic device may be provided with conductive structures such as conductive housing structures. A visible-light-reflecting coating may be formed on the conductive structures. The coating may have adhesion and transition layers, an opaque coloring layer on the adhesion and transition layers, and a three-layer thin-film interference filter on the opaque coloring layer. The three-layer thin-film interference filter may have an uppermost SiC layer, a lowermost SiCrCN layer, and a CrC layer interposed between the SiC layer and the SiCrCN layer. The opaque color layer may be a CrSiCN layer. The coating may exhibit a light violet color that has a relatively uniform visual response even when the underlying conductive structures have a three-dimensional shape.

This application claims the benefit of U.S. Provisional Patent Application No. 63/403,499, filed Sep. 2, 2022, which is hereby incorporated by reference herein in its entirety.

### FIELD

This disclosure relates generally to coatings for electronic device structures and, more particularly, to visible-light-reflecting coatings for conductive electronic device structures.

### BACKGROUND

Electronic devices such as cellular telephones, computers, watches, and other devices contain conductive structures such as conductive housing structures. The conductive structures are provided with a coating that reflects particular wavelengths of light so that the conductive components exhibit a desired visible color.

It can be challenging to provide coatings such as these with a desired color brightness. In addition, if care is not taken, the coatings may exhibit unsatisfactory optical performance across different operating environments and conductive structure geometries.

### SUMMARY

An electronic device may include conductive structures such as conductive housing structures. A visible-light-reflecting coating may be formed on the conductive structures. The coating may have adhesion and transition layers, an opaque coloring layer on the adhesion and transition layers, and a multi-layer thin-film interference filter on the opaque coloring layer. The multi-layer thin-film interference filter may be a three-layer thin-film interference filter. The three-layer thin-film interference filter may have an uppermost SiC layer, a lowermost SiCrCN layer, and a CrC layer interposed between the SiC layer and the SiCrCN layer. The opaque color layer may be a CrSiCN layer. The coating may exhibit a light violet color that has a relatively uniform visual response even when the underlying conductive structures have a three-dimensional shape.

An aspect of the disclosure provides an apparatus. The apparatus can include a conductive substrate. The apparatus can include a coating on the conductive substrate and having a color. The coating can include adhesion and transition layers. The coating can include a thin-film interference filter on the adhesion and transition layers, wherein the thin-film interference filter comprises a SiC layer that forms an uppermost layer of the thin-film interference filter, a SiCrCN layer that forms a lowermost layer of the thin-film interference filter, and a CrC layer interposed between the SiCrCN layer and the SiC layer.

Another aspect of the disclosure provides an apparatus. The apparatus can include a conductive substrate. The apparatus can include a coating on the conductive substrate and having a color. The coating can include adhesion and transition layers. The coating can include an opaque layer on the adhesion and transition layers. The coating can include a three-layer thin-film interference filter on the opaque layer, the three-layer thin-film interference filter having an uppermost layer comprising SiC.

Yet another aspect of the disclosure provides an electronic device. The electronic device can include a conductive structure. The electronic device can include a coating on the conductive structure and having a color. The coating can include adhesion and transition layers. The coating can include an opaque layer on the adhesion and transition layers. The coating can include a two-layer thin-film interference filter on the opaque layer.

### BRIEF DESCRIPTION OF THE DRAWINGS

FIG. 1 is a perspective view of an illustrative electronic device of the type that may be provided with conductive structures and visible-light-reflecting coatings in accordance with some embodiments.

FIG. 2 is cross-sectional side view of an illustrative electronic device having conductive structures that may be provided with visible-light-reflecting coatings in accordance with some embodiments.

FIG. 3 is an exploded cross-sectional side view of an illustrative conductive housing sidewall that may be provided with a visible-light-reflecting coating in accordance with some embodiments.

FIG. 4 is a cross-sectional side view of an illustrative visible-light-reflecting coating having a multi-layer interference film and an underlying opaque coloring layer in accordance with some embodiments.

FIG. 5 is a cross-sectional side view of an illustrative visible-light-reflecting coating having a three-layer interference film with an uppermost SiC layer, a CrC layer, and a lowermost SiCrCN layer on an underlying CrSiCN opaque coloring layer in accordance with some embodiments.

FIG. 6 is a plot that shows an exemplary composition (atomic percentage) at different depths through an illustrative visible-light-reflecting coating of the type shown in FIG. 5 in accordance with some embodiments.

FIG. 7 is a plot of L*a* and L*b* color spaces for illustrative visible-light-reflecting coatings of the type shown in FIG. 5 in accordance with some embodiments.

FIG. 8 is a cross-sectional side view of an illustrative visible-light-reflecting coating having a three-layer interference film with an uppermost SiC layer, a CrN layer, and a lowermost SiC layer in accordance with some embodiments.

FIGS. 9-14 are cross-sectional side views of illustrative visible-light-reflecting coatings having a two-layer interference film on an underlying opaque coloring layer in accordance with some embodiments.

### DETAILED DESCRIPTION

Electronic devices and other items may be provided with conductive structures. Coatings may be formed on the conductive structures to reflect particular wavelengths of visible light so that the conductive structures exhibit a desired color. A visible-light-reflecting coating may be deposited on a conductive substrate. The coating may include adhesion and transition layers on the substrate, an opaque coloring layer on the adhesion and transition layers, and a three-layer thin-film interference filter on the opaque coloring layer. The thin-film interference filter may have an uppermost SiC layer. The thin-film interference filter may have a lowermost SiCrCN layer. The thin-film interference filter may have a middle CrC layer. The opaque coloring layer may be a CrSiCN layer. The coating may exhibit a robust light violet color that exhibits a relatively uniform visual response when the underlying conductive structures have a three-dimensional shape.

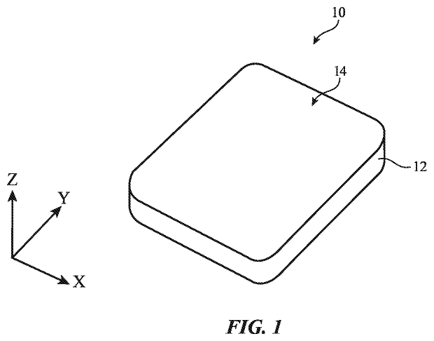

An illustrative electronic device of the type that may be provided with conductive structures and visible-light-reflecting coatings is shown in FIG. 1. Electronic device 10 of FIG. 1 may be a computing device such as a laptop computer, a computer monitor containing an embedded computer, a tablet computer, a cellular telephone, a media player, or other handheld or portable electronic device, a smaller device such as a wristwatch device (e.g., a watch with a wrist strap), a pendant device, a headphone or earpiece device, a device embedded in eyeglasses or other equipment worn on a user's head (e.g., a head mounted device), or other wearable or miniature device, a television, a computer display that does not contain an embedded computer, a gaming device, a navigation device, an embedded system such as a system in which electronic equipment with a display is mounted in a kiosk or automobile, a wireless base station, a home entertainment system, a wireless speaker device, a wireless access point, equipment that implements the functionality of two or more of these devices, or other electronic equipment. In the illustrative configuration of FIG. 1, device 10 is a portable device having a substantially rectangular lateral outline such as a cellular telephone or tablet computer. Other configurations may be used for device 10 if desired. The example of FIG. 1 is merely illustrative.

In the example of FIG. 1, device 10 includes a display such as display 14. Display 14 may be mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Housing 12 may have metal sidewalls or sidewalls formed from other materials. Examples of metal materials that may be used for forming housing 12 include stainless steel, aluminum, silver, gold, titanium, metal alloys, or any other desired conductive material.

Display 14 may be formed at (e.g., mounted on) the front side (face) of device 10. Housing 12 may have a rear housing wall on the rear side (face) of device 10 that opposes the front face of device 10. Conductive housing sidewalls in housing 12 may surround the periphery of device 10. The rear housing wall of housing 12 may be formed from conductive materials and/or dielectric materials.

The rear housing wall of housing 12 and/or display 14 may extend across some or all of the length (e.g., parallel to the X-axis of FIG. 1) and width (e.g., parallel to the Y-axis) of device 10. Conductive sidewalls of housing 12 may extend across some or all of the height of device 10 (e.g., parallel to Z-axis).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode (OLED) display pixels, an array of electrowetting display pixels, or display pixels based on other display technologies.

Display 14 may be protected using a display cover layer. The display cover layer may be formed from a transparent material such as glass, plastic, sapphire or other crystalline dielectric materials, ceramic, or other clear materials. The display cover layer may extend across substantially all of the length and width of device 10, for example.

Device 10 may include one or more buttons. The buttons may be formed from a conductive button member that is located within (e.g., protruding through) openings in housing 12 or openings in display 14 (as examples). Buttons may be rotary buttons, sliding buttons, buttons that are actuated by pressing on a movable button member, etc.

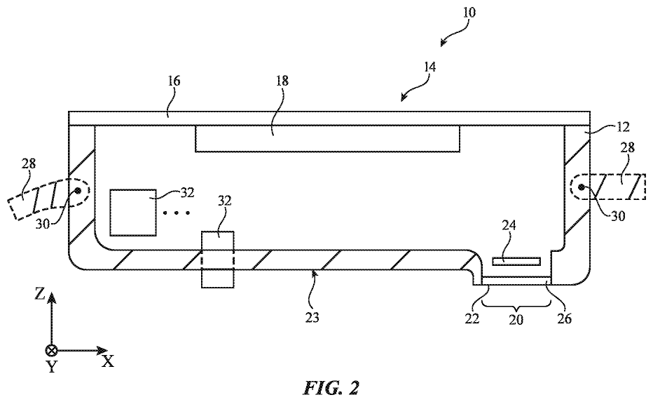

A cross-sectional side view of device 10 in an illustrative configuration in which display 14 has a display cover layer is shown in FIG. 2. As shown in FIG. 2, display 14 may have one or more display layers that form pixel array 18. During operation, pixel array 18 forms images for a user in an active area of display 14. Display 14 may also have inactive areas (e.g., areas along the border of pixel array 18) that are free of pixels and that do not produce images. Display cover layer 16 of FIG. 2 overlaps pixel array 18 in the active area and overlaps electrical components in device 10.

Display cover layer 16 may be formed from a transparent material such as glass, plastic, ceramic, or crystalline materials such as sapphire. Illustrative configurations in which a display cover layer and other transparent members in device 10 (e.g., windows for cameras and other light-based devices that are formed in openings in housing 12) are formed from a hard transparent crystalline material such as sapphire (sometimes referred to as corundum or crystalline aluminum oxide) may sometimes be described herein as an example. Sapphire makes a satisfactory material for display cover layers and windows due to its hardness (9 Mohs). In general, however, these transparent members may be formed from any suitable material.

Display cover layer 16 for display 14 may be planar or curved and may have a rectangular outline, a circular outline, or outlines of other shapes. If desired, openings may be formed in the display cover layer. For example, an opening may be formed in the display cover layer to accommodate a button, a speaker port, or other component. Openings may be formed in housing 12 to form communications or data ports (e.g., an audio jack port, a digital data port, a port for a subscriber identity module (SIM) card, etc.), to form openings for buttons, or to form audio ports (e.g., openings for speakers and/or microphones).

Device 10 may, if desired, be coupled to a strap such as strap 28 (e.g., in scenarios where device 10 is a wristwatch device). Strap 28 may be used to hold device 10 against a user's wrist (as an example). Strap 28 may sometimes be referred to herein as wrist strap 28. In the example of FIG. 2, wrist strap 28 is connected to attachment structures 30 in housing 12 at opposing sides of device 10. Attachment structures 30 may include lugs, pins, springs, clips, brackets, and/or other attachment mechanisms that configure housing 12 to receive wrist strap 28. Configurations that do not include straps may also be used for device 10.

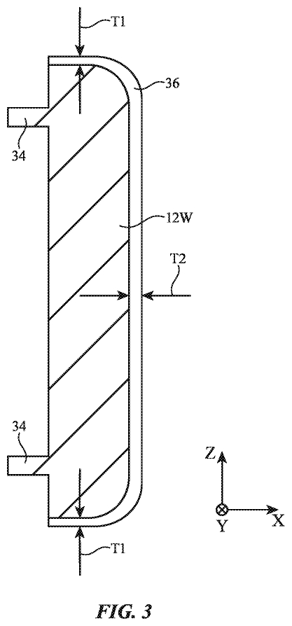

If desired, light-based components such as light-based components 24 may be mounted in alignment with an opening 20 in housing 12. Opening 20 may be circular, may be rectangular, may have an oval shape, may have a triangular shape, may have other shapes with straight and/or curved edges, or may have other suitable shapes (outlines when viewed from above). Window member 26 may be mounted in window opening 20 of housing 12 so that window member 26 overlaps component 18. A gasket, bezel, adhesive, screws, or other fastening mechanisms may be used in attaching window member 26 to housing 12. Surface 22 of window member 26 may lie flush with exterior surface 23 of housing 12, may be recessed below exterior surface 23, or may, as shown in FIG. 3, be proud of exterior surface 23 (e.g., surface 22 may lie in a plane that protrudes away from surface 23 in the −Z direction). In other words, window member 26 may be mounted to a protruding portion of housing 12. Surface 23 may, for example, form the rear face of housing 12.

Conductive structures in device 10 may be provided with a visible-light-reflecting coating that reflects certain wavelengths of light so that the conductive structures exhibit a desired aesthetic appearance (e.g., a desired color, reflectivity, etc.). The conductive structures in device 10 may include, for example, conductive portions of housing 12 (e.g., conductive sidewalls for device 10, a conductive rear wall for device 10, a protruding portion of housing 12 used to mount window member 26, etc.), attachment structures 30, conductive portions of wrist strap 28, a conductive mesh, conductive components 32, and/or any other desired conductive structures on device 10. Conductive components 32 may include internal components (e.g., internal housing members, a conductive frame, a conductive chassis, a conductive support plate, conductive brackets, conductive clips, conductive springs, input-output components or devices, etc.), components that lie both at the interior and exterior of device 10 (e.g., a conductive SIM card tray or SIM card port, a data port, a microphone port, a speaker port, a conductive button member for a ringer button, power button, volume button, or other buttons, etc.), components that are mounted at the exterior of device 10 (e.g., conductive portions of strap 28 such as a clasp for strap 28), and/or any other desired conductive structures on device 10.

FIG. 3 is an exploded cross-sectional side view of a conductive sidewall in device 10 that may be provided with a visible-light-reflecting coating. As shown in FIG. 3, housing 12 may include peripheral conductive housing structures such as conductive sidewall 12W. Conductive sidewall 12W may, for example, run around the lateral periphery of device 10 in the X-Y plane (e.g., conductive sidewall 12W may run around the periphery of display 14 of FIG. 2 and may serve as a conductive bezel for the display).

Conductive sidewall 12W may include one or more ledges 34. Ledges 34 may be used to support a conductive and/or dielectric rear wall for device 10 (e.g., at the rear face of device 10) and/or to support display cover layer 16 of FIG. 2 (e.g., at the front face of device 10). In order to provide conductive sidewall 12W with a desired visible color, a visible-light-reflecting coating such as coating 36 may be deposited onto conductive sidewall 12W (e.g., all of conductive sidewall 12W, the portions of conductive sidewall 12W at the exterior of device 10, etc.). Coating 36 may also be deposited over other conductive structures in device 10 (e.g., conductive components 32 of FIG. 2, other conductive portions of housing 12, etc.).

In practice, the coating may have different thicknesses across its surface area due to changes in the underlying geometry of the conductive structure (e.g., because of coating deposition equipment limitations in depositing uniform coatings across the underlying geometry). For example, coating 36 of FIG. 3 may exhibit a first thickness T1 at the bottom and top edges of conductive sidewall 12W (e.g., where conductive sidewall 12W exhibits a curved three-dimensional shape) but may exhibit a second thickness T2 along the center of conductive sidewall 12W (e.g., where conductive sidewall 12W exhibits a substantially planar shape). Thickness T2 may represent the maximum thickness of coating 36 across its surface area (e.g., 100% thickness). Thickness T1 may be less than thickness T2 (e.g., 30-70% of thickness T2). If care is not taken, variations in thickness along the surface area of coating 36 can undesirably alter the color of visible light reflected by the coating and thus the aesthetic appearance of the underlying conductive structure.

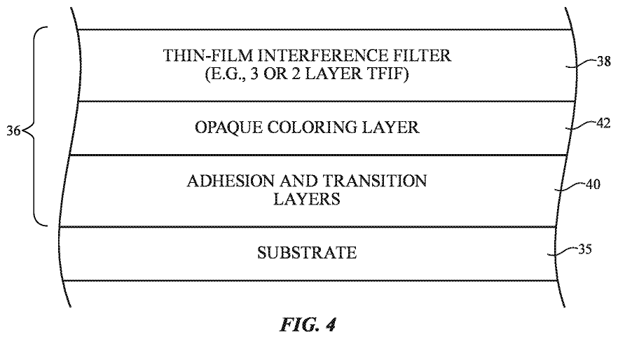

FIG. 4 is a cross-sectional diagram of a visible-light-reflecting coating having a multi-layer thin-film interference filter that may be provided on conductive structures in device 10 (e.g., portions of housing 12 of FIGS. 1 and 2, conductive components 32 of FIG. 2, conductive sidewall 12W of FIG. 3, etc.). As shown in FIG. 4, a visible-light-reflecting coating such as coating 36 may be disposed (e.g., deposited, layered, formed, etc.) on a conductive substrate such as substrate 35. Substrate 35 may be a conductive structure in device 10 such as a conductive portion of housing 12 (FIGS. 1 and 2), a conductive component 32 (FIG. 2), or conductive sidewall 12W (FIG. 3). Substrate 35 may be thicker than coating 36. The thickness of substrate 35 may be 0.1 mm to 5 mm, more than 0.3 mm, more than 0.5 mm, between 5 mm and 20 mm, less than 5 mm, less than 2 mm, less than 1.5 mm, or less than 1 mm (as examples). Substrate 35 may include stainless steel, aluminum, titanium, or other metals or alloys. In other suitable arrangements, substrate 35 may be an insulating substrate such as a ceramic substrate, a glass substrate, or substrates formed from other materials.

Coating 36 may include adhesion and transition layers 40 on substrate 35. Coating 36 may include an opaque color layer such as opaque coloring layer 42 on adhesion and transition layers 40. Coating 36 may include a multi-layer thin-film interference filter such as thin-film interference filter (TFIF) 38 on opaque coloring layer 42. An optional oleophobic coating or other films, coatings, or layers (e.g., layers that do not substantially contribute to the color response of the coating) may be layered over thin-film interference filter 38 if desired. Opaque coloring layer 42 may, for example, have a first lateral surface that directly contacts adhesion and transition layers 40 and may have a second lateral surface opposite the first lateral surface. Thin-film interference filter 38 may, for example, have a third lateral surface that directly contacts the second lateral surface and may have a fourth lateral surface opposite the third lateral surface (e.g., the fourth lateral surface may form an uppermost or outermost layer of coating 36). Thin-film interference filter 38 may include multiple layers (films) stacked on opaque coloring layer 42. In some implementations, thin-film interference filter 38 may include three stacked layers (films). In other implementations, thin-film interference filter 38 may include two stacked layers (films). This is merely illustrative and, if desired, thin-film interference filter 38 may include other numbers of layers (e.g., four layers, five layers, more than five layers, etc.).

The layers of coating 36 may be deposited on substrate 35 using any suitable deposition techniques. Examples of techniques that may be used for depositing the layers in coating 36 include physical vapor deposition (e.g., evaporation and/or sputtering), cathodic arc deposition, chemical vapor deposition, ion plating, laser ablation, etc. For example, coating 36 may be deposited on substrate 35 in a deposition system having deposition equipment (e.g., a cathode). Substrate 35 may be moved (e.g., rotated) within the deposition system while the deposition equipment (e.g., the cathode) deposits the layers of coating 36. If desired, substrate 35 may be moved/rotated dynamically with respect to speed and/or orientation relative to the deposition equipment (e.g., the cathode) during deposition. This may help provide coating 36 with as uniform a thickness as possible across its area, even in scenarios where substrate 35 has a three-dimensional shape (e.g., minimizing the difference between thicknesses T1 and T2 of FIG. 3).

Thin-film interference filter 38 may be formed from a stack of layers of material such as inorganic dielectric layers with different index of refraction values. The thin-film interference filter layers may have higher index of refraction values (sometimes referred to as “high” index values) and lower index of refraction values (sometimes referred to as “low” index values). The high index layers may be interleaved with the low index layers if desired. Incident light may be transmitted through each of the layers in thin-film interference filter 38 while also reflecting off the interfaces between each of the layers, as well as at the interface between the thin-film interference filter and opaque coloring layer 42 and at the interface between the thin-film interference filter and air. By controlling the thickness and index of refraction (e.g., composition) of each layer in thin-film interference filter 38, the light reflected at each interface may destructively and/or constructively interfere at a selected set of wavelengths such that reflected light that passes out of the thin-film interference filter 38 is perceived by an observer with a desired color and brightness across a corresponding range of viewing angles (angles of incidence, e.g., from 0 to 60 degrees relative to a normal axis of the conductive structure), while also exhibiting a response that is relatively invariant across the lateral area of the coating even when deposited onto an underlying substrate 35 having a three-dimensional (e.g., curved) shape.

Unlike the layers of thin-film interference filter 38, opaque color layer 42 is substantially opaque and does not transmit light incident upon coating 36. On the other hand, opaque color layer 42 may reflect incident light received through thin-film interference filter 38 back towards and through thin-film interference filter 38. The thickness and/or composition of opaque coloring layer 42 may contribute to the color response of the light upon exiting coating 36 as viewed by a user (e.g., in combination with the interference effects imparted to the transmitted and reflected light by thin-film interference filter 38). Opaque color layer 42 may sometimes also be referred to herein as a non-interference filter layer or an intrinsic color layer.

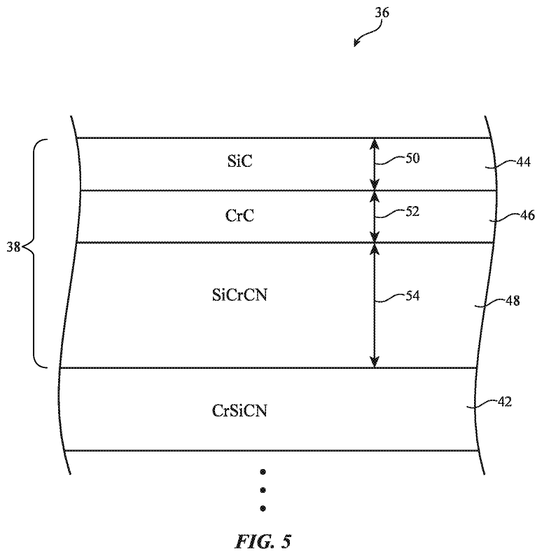

FIG. 5 is a cross-sectional side view showing one illustrative composition for coating 36. Substrate 35 and adhesion and transition layers 40 (FIG. 4) have been omitted from FIG. 5 for the sake of clarity. In general, adhesion and transition layers 40 may include a seed (adhesion) layer on substrate 35 and one or more transition layers on the seed layer. The seed layer may couple substrate 35 to the transition layer(s) (e.g., the transition layer(s) may be interposed between the seed layer and opaque coloring layer 42). The seed layer may be formed from chromium (Cr) whereas the transition layer is formed from chromium silicon nitride (CrSiN), in one example. This is merely illustrative. If desired, the seed layer and/or the transition layer(s) may include chromium nitride (CrN), chromium silicon (CrSi), titanium (Ti), chromium silicon nitride (CrSiN), chromium silicon carbonitride (CrSiCN), chromium silicon carbide (CrSiC), chromium carbonitride (CrCN), other metals, metal alloys, and/or other materials.

In the example of FIG. 5, thin-film interference filter 38 is a three-layer interference filter having three layers (e.g., layers 44, 46, and 48). As shown in FIG. 5, thin-film interference filter 38 may include a lowermost (bottom) layer 48 that is layered onto opaque coloring layer 42. Layer 48 may have thickness 54. Thin-film interference filter 38 may include a middle layer 46 that is layered onto layer 48. Layer 46 may have thickness 52. Thin-film interference filter 38 may include an uppermost layer 44 that is layered onto layer 46. Layer 44 may have thickness 50. Thickness 54 may be greater than thicknesses 52 and 50.

Layer 44 may include silicon carbide (SiC) and may therefore sometimes be referred to herein as SiC layer 44. Layer 46 may include chromium carbide (CrC) and may therefore sometimes be referred to herein as CrC layer 46. Layer 48 may include silicon chromium carbo-nitride (SiCrCN) and may therefore sometimes be referred to herein as SiCrCN layer 48. Layer 76 may include SiH and may therefore sometimes be referred to herein as SiH layer 76. Put differently, thin-film interference filter 38 may include an uppermost SiC layer 44, a lowermost SiCrCN layer 48, and a middle CrC layer 46 interposed between layers 44 and 48. The example of FIG. 5 is merely illustrative. The layers of thin-film interference filter 38 may be disposed in other orders and/or may have other compositions. Opaque coloring layer 42 may include chromium silicon carbo-nitride (CrSiCN) and may therefore sometimes be referred to herein as CrSiCN layer 42. CrSiCN layer 42 may include a higher percentage of Cr than Si atoms, whereas SiCrCN layer 48 includes a higher percentage of Si atoms than Cr atoms.

The composition and thicknesses of the layers of thin-film interference filter 38 may be selected so that coating 36 exhibits a violet color across a predetermined range of angles of incidence. The thickness 54 of SiCrCN layer 48 may, for example, be selected to be 50-100 nm, 40-120 nm, 80-100 nm, 75-95 nm, 30-150 nm, 80-90 nm, 70-95 nm, 60-70 nm, 50-80 nm, 45-85 nm, greater than 30 nm, greater than 50 nm, greater than 80 nm, greater than 60 nm, less than 70 nm, less than 100 nm, less than 150 nm, or other thicknesses. The thickness 52 of CrC layer 46 may be selected to be 20-30 nm, 15-25 nm, 15-30 nm, 10-30 nm, 10-40 nm, 20-24 nm, 18-26 nm, 5-35 nm, 8-28 nm, greater than 10 nm, greater than 15 nm, greater than 20 nm, less than 25 nm, less than 30 nm, less than 35 nm, less than 40 nm, or other thicknesses. The thickness 50 of SiC layer 44 may be selected to be 20-30 nm, 20-35 nm, 15-35 nm, 25-31 nm, 18-33 nm, 10-40 nm, 5-50 nm, greater than 10 nm, greater than 15 nm, greater than 20 nm, greater than 25 nm, less than 25 nm, less than 30 nm, less than 35 nm, less than 40 nm, or other thicknesses. The thickness of opaque coloring layer 42 may be greater than thickness 54 and/or greater than the thickness of the entire thin-film interference filter 38 (e.g., 400-600 nm, 500 nm, 300-700 nm, 200-800 nm, or other thicknesses).

In a first implementation that is described herein as an example, thickness 50 is greater than thickness 52 (e.g., 1-10 nm greater, 5-15 nm greater, more than 5 nm greater, less than 10 nm greater, less than 20 nm greater, etc.) and less than half of thickness 54. In a second implementation that is described herein as an example, thickness 52 is greater than thickness 50 (e.g., 1-10 nm greater, 2-6 nm greater, 5 nm greater, less than 10 nm greater, less than 15 nm greater, more than 1 nm greater, etc.) and thickness 52 is less than the thickness 54 in the first implementation (e.g., 20 nm less, 10-30 nm less, 30 nm less, etc.).

FIG. 6 is a plot of the composition of coating 36. The curves of FIG. 6 may be generated using an energy dispersive spectroscopy (EDS) line scan that measures the atomic percentage of different elements at different depths from the exterior surface and through the thickness of coating 36.

As shown in FIG. 6, curve 56 plots the atomic percentage (%) of chromium (Cr) atoms through the thickness of coating 36. Curve 58 plots the atomic percentage of silicon (Si) atoms through the thickness of coating 36. Curve 60 plots the atomic percentage of nitrogen (N) atoms through the thickness of coating 36. Curve 62 plots the atomic percentage of carbon (C) atoms through the thickness of coating 36.

As shown by curve 56, coating 36 exhibits a relatively high percentage (e.g., a peak) of Cr atoms within CrC layer 46 of FIG. 5 (e.g., within the middle layer of the coating, located deeper than SiC coating 44 and shallower than SiCrCN coating 48, across thickness 52). Coating 36 also exhibits a relatively high percentage (e.g., a peak) of Cr atoms within the opaque coloring layer (e.g., CrSiCN layer 42 of FIG. 5).

As shown by curve 58, coating 36 exhibits a relatively high percentage (e.g., a peak) of Si atoms within SiC layer 44 of FIG. 5 (e.g., within the uppermost layer of the coating, located shallower than CrC layer 46, across thickness 50). Coating 36 also exhibits high percentages (e.g., peaks) of Si atoms within SiCrCN layer 48 of FIG. 5 (e.g., within the lowermost layer of the coating, located deeper than CrC layer 46 and shallower than the opaque coloring layer, across thickness 54) and within opaque coloring layer 42 (e.g., CrSiCN layer 42 of FIG. 5).

As shown by curve 60, coating 36 exhibits a relatively high percentage (e.g., a peak) of N atoms within SiCrCN layer 48 of FIG. 5. Coating 36 also exhibits a relatively high percentage (e.g., a peak) of N atoms within opaque coloring layer 42 (e.g., CrSiCN layer 42 of FIG. 5). As shown by curve 62, coating 36 exhibits relatively high percentages (e.g., peaks) of C atoms within SiC layer 44, CrC layer 46, SiCrCN layer 48, and opaque coloring layer 42.

Coating 36 may exhibit different amounts of Cr, Si, N, and C atoms in each of the layers. For example, the composition of SiC layer 44 of FIG. 4 may be selected such that the atomic percentage of Cr atoms in SiC layer 44 is 40-50%, 30-60%, 25-52%, 30-57%, greater than 30%, greater than 40%, greater than 20%, less than 50%, less than 60%, or other values. The composition of CrC layer 46 may be selected such that the atomic percentage of Cr atoms in CrC layer 46 is 40-50%, 30-60%, 25-52%, 30-57%, greater than 30%, greater than 40%, greater than 20%, less than 50%, less than 60%, or other values.

The composition of SiCrCN layer 48 may be selected such that the atomic percentage of Si atoms in SiCrCN layer 48 is 10-20%, 5-25%, 12-27%, 5-30%, greater than 5%, greater than 10%, greater than 15%, less than 20%, less than 25%, less than 30%, or other values. The composition of SiCrCN layer 48 may be selected such that the atomic percentage of C atoms in SiCrCN layer 48 is greater than the atomic percentage of Si atoms (e.g., 20-40%, 10-50%, greater than 10%, greater than 20%, greater than 30%, less than 40%, less than 50%, or other values). The composition of SiCrCN layer 48 may be selected such that the atomic percentage of N atoms in SiCrCN layer 48 is greater than the atomic percentages of C atoms, Si atoms, and Cr atoms in SiCrCN layer 48 (e.g., 40-50%, 30-60%, 35-65%, greater than 30%, greater than 40%, greater than 45%, less than 50%, less than 60%, or other values).

The composition of opaque coloring layer 42 may be selected such that the atomic percentage of Cr atoms in opaque coloring layer 42 is greater than the atomic percentages of Si, C, and N atoms in opaque coloring layer 42 (e.g., 50-60%, 40-70%, 35-65%, greater than 30%, greater than 40%, greater than 50%, less than 60%, less than 70%, or other values). The composition of opaque coloring layer 42 may be selected such that the atomic percentage of Si atoms in opaque coloring layer 42 is greater than the atomic percentages of C and N atoms in opaque coloring layer 42 (e.g., 10-20%, 5-25%, 12-27%, 5-30%, greater than 5%, greater than 10%, greater than 15%, less than 20%, less than 25%, less than 30%, or other values). The composition of opaque coloring layer 42 may be selected such that the atomic percentage of N atoms in opaque coloring layer 42 is greater than the atomic percentage of C atoms in opaque coloring layer 42. These examples are merely illustrative and, in general, the layers of coating 36 may have other compositions.

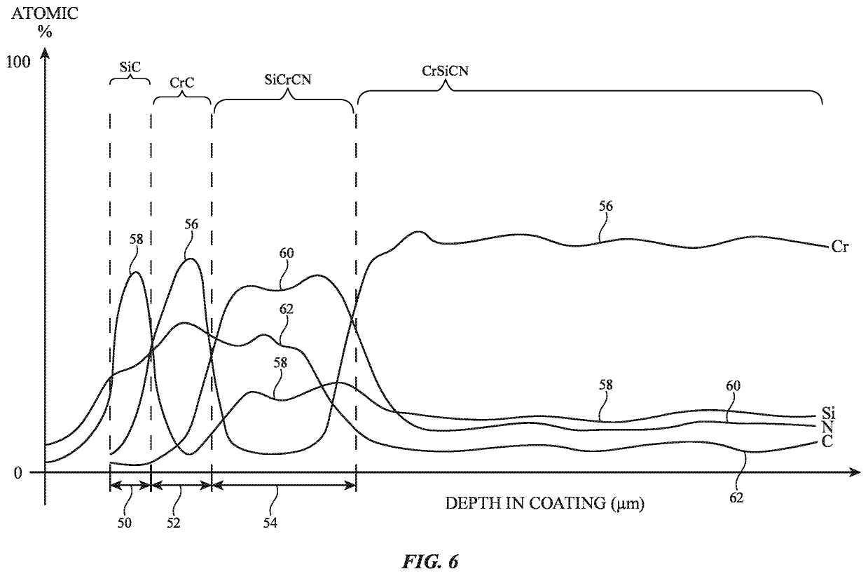

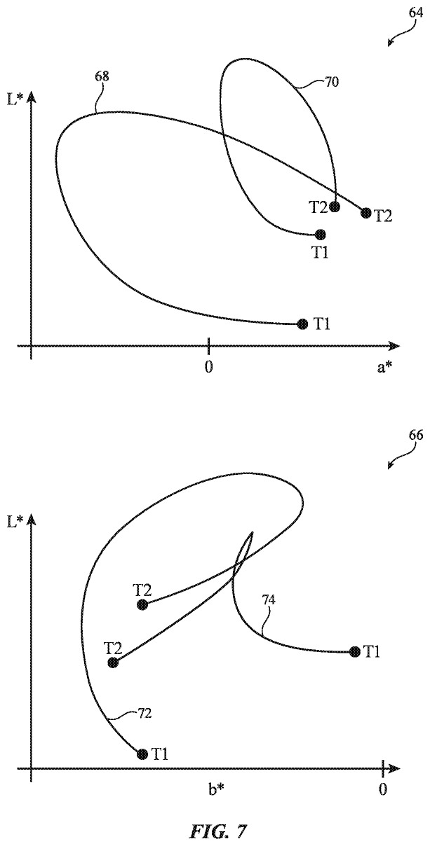

In practice, it can be difficult to provide coating 36 with a uniform thickness across its surface (lateral) area, particularly when depositing on substrates 35 having non-planar three-dimensional shapes. The three-layer thin-film interference filter with underlying opaque coloring layer of FIG. 5 may provide a relatively stable color response across the surface area of coating 36 even as the overall thickness of the coating varies due to geometry variations in the underlying substrate 35. FIG. 7 includes a plot 64 of L*a* color space and a plot 66 of L*b* color spacing showing the color response of the coatings 36 in FIG. 5 at different overall coating thicknesses.

As shown in FIG. 7, curves 68 and 72 plot the color response of the coating 36 from a location of maximum (100%) thickness (e.g., thickness T2 as shown in FIG. 3) to a location of minimum thickness (e.g., thickness T1 of FIG. 3, which may be as low as 30% of the maximum thickness) for the first implementation of coating 36 of FIG. 5. Curves 70 and 74 plot the color response of the coating 36 from the location of maximum thickness to the location of minimum thickness for the second implementation of coating 36 of FIG. 5. As shown by curves 68-74, coating 36 exhibits a relatively stable color response as thickness varies from thickness T2 to thickness T1 across the surface area of the coating (e.g., as the geometry of the underlying substrate 35 changes). The second implementation for coating 36 may, for example, exhibit an even more stable (e.g., tighter) color response than the first implementation for coating 36. Curves 68-74 may have other shapes in practice.

The layer thicknesses and compositions of the layers of coating 36 of FIG. 5 may configure coating 36 to exhibit a violet color (e.g., may impart substrate 35 with a violet color). At a location of maximum thickness (e.g., thickness T2) and an angle of incidence of zero degrees, the L* value (e.g., in a L*a*b* color space or another color space) of coating 36 may be, for example, 50-60, 50-55, 45-55, 40-60, 52-55, 51-54, greater than 40, greater than 45, greater than 50, less than 55, less than 60, less than 65, greater than 30, or other values. At the location of maximum thickness and the angle of incidence of zero degrees, the a* value (e.g., in the L*a*b* color space or another color space) of coating 36 may be, for example, 0-5, 3-4, 1-4, 1-6, 0-10, −5-15, 3.1-4.2, greater than 3, greater than 2, greater than 1, greater than 0, less than 4, less than 5, less than 10, or other values. At the location of maximum thickness and the angle of incidence of zero degrees, the b* value (e.g., in the L*a*b* color space or another color space) of coating 36 may be, for example, between −15 and −10, between −5 and −20, between −14 and −15, between −13 and −16, between −13 and −15, less than 0, less than −5, less than −10, less than −13, greater than −15, greater than −20, greater than −25, or other values.

The example of FIG. 5 in which layer 46 is a CrC layer and layer 48 is an SiCrCN layer is merely illustrative. In other implementations, CrC layer 46 of FIG. 5 may be replaced with a CrN layer 78 and SiCrCN layer 48 of FIG. 5 may be replaced with another SiC layer 80, as shown in FIG. 8. Opaque coloring layer 42 (FIG. 5), adhesion and transition layers 40 (FIG. 4), and substrate 35 (FIG. 4) have been omitted from FIG. 8 for the sake of clarity. In the example of FIG. 8, the thickness of SiC layer 44 may be approximately equal to the thicknesses of layers 78 and 80 (e.g., 10-30 nm, 15-25 nm, 5-25 nm, 18-34 nm, 5-35 nm, greater than 10 nm, greater than 15 nm, greater than 5 nm, less than 25 nm, less than 30 nm, or other thicknesses). The underlying opaque coloring layer 42 for coating 36 of FIG. 8 (not shown) may be a CrN opaque coloring layer, as one example.

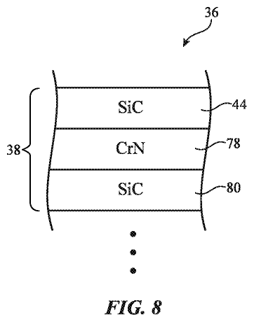

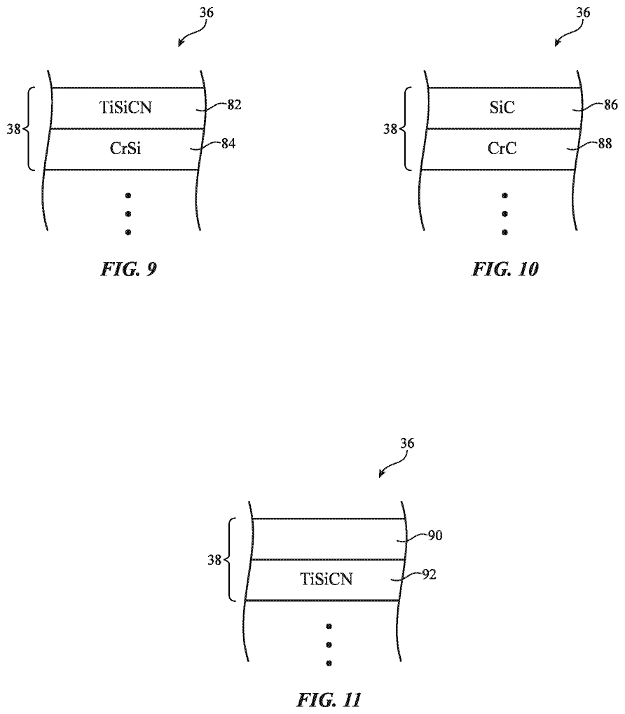

The examples of FIGS. 5 and 8 in which thin-film interference filter 38 is a three-layer thin-film interference filter is merely illustrative. If desired, thin-film interference filter 38 may be a two-layer thin-film interference filter. FIGS. 9-14 illustrate six examples of coatings 36 having a two-layer thin-film interference filter. The underlying opaque coloring layer 42 has been omitted from FIGS. 9-11 for the sake of clarity. The underlying adhesion and transition layers 40 and substrate 35 (FIG. 4) have been omitted from FIGS. 9-14 for the sake of clarity.

As shown in FIG. 9, thin-film interference filter 38 of coating 36 may include a lowermost layer 84 layered on (contacting) the underlying opaque coloring layer and an uppermost layer 82 on layer 84. Layer 84 may include chromium silicide (CrSi) and may therefore sometimes be referred to herein as CrSi layer 84. Layer 82 may include titanium silicon carbo-nitride (TiSiCN) and may therefore sometimes be referred to herein as TiSiCN layer 82. Layer 84 may have a first thickness (e.g., 50-90 nm, 60-80 nm, 65-75 nm, more than 60 nm, more than 50 nm, less than 80 nm, less than 90 nm, or other thicknesses) whereas layer 82 has a second thickness less than the first thickness (e.g., 40-60 nm, 30-70 nm, 20-80 nm, 45-55 nm, more than 40 nm, more than 30 nm, less than 60 nm, less than 70 nm, or other thicknesses).

As shown in FIG. 10, thin-film interference filter 38 of coating 36 may include a lowermost layer 88 layered on (contacting) the underlying opaque coloring layer and an uppermost layer 86 on layer 88. Layer 88 may include CrC and may therefore sometimes be referred to herein as CrC layer 88. Layer 86 may include SiC and may therefore sometimes be referred to herein as SiC layer 86. Layers 88 and 86 may have approximately equal thicknesses (e.g., 10-30 nm, 5-35 nm, 15-25 nm, more than 15 nm, more than 10 nm, less than 25 nm, less than 30 nm, less than 40 nm, or other thicknesses). The underlying opaque coloring layer 42 for coating 36 of FIG. 10 (not shown) may be a titanium silicon nitride (TiSiN) opaque coloring layer, as one example.

As shown in FIG. 11, thin-film interference filter 38 of coating 36 may include a lowermost layer 92 layered on (contacting) the underlying opaque coloring layer and an uppermost layer 90 on layer 92. Layer 92 may include TiSiCN and may therefore sometimes be referred to herein as TiSiCN layer 92. Layer 90 may include any desired materials. Layer 92 may have a first thickness (e.g., 30-50 nm, 20-60 nm, 35-45 nm, more than 30 nm, more than 20 nm, less than 50 nm, less than 60 nm, or other thicknesses) whereas layer 90 has a second thickness less than the first thickness (e.g., 10-30 nm, 5-25 nm, 15-25 nm, more than 15 nm, more than 10 nm, less than 30 nm, less than 40 nm, or other thicknesses). In other implementations, layers 90 and 92 may have approximately equal thicknesses (e.g., 10-30 nm, 5-35 nm, 15-25 nm, more than 15 nm, more than 10 nm, less than 25 nm, less than 30 nm, less than 40 nm, or other thicknesses).

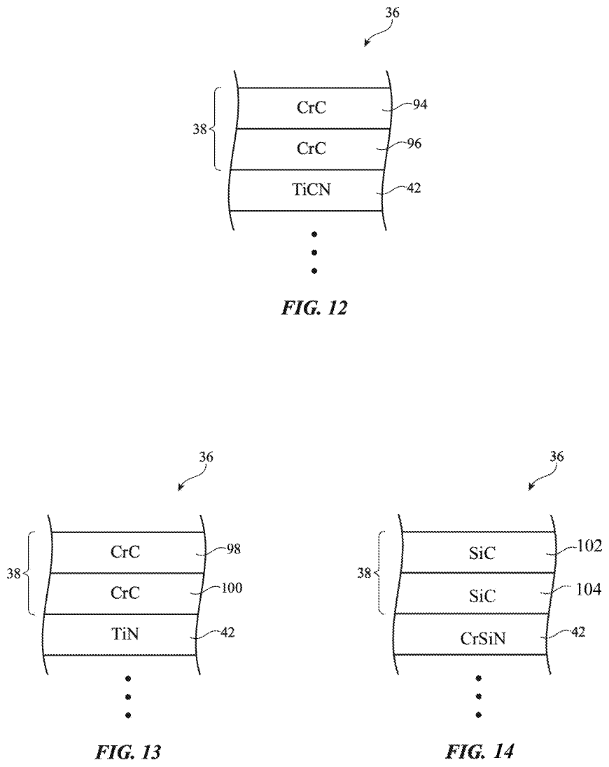

As shown in FIG. 12, thin-film interference filter 38 of coating 36 may include a lowermost layer 96 layered on (contacting) opaque coloring layer 42 and an uppermost layer 94 on layer 96. Layers 94 and 96 may both include CrC (e.g., with different amounts of Cr and C between the layers to configure the layers to exhibit different refractive indices). Layers 94 and 96 may have approximately equal thicknesses (e.g., 10-30 nm, 5-35 nm, 15-25 nm, more than 15 nm, more than 10 nm, less than 25 nm, less than 30 nm, less than 40 nm, or other thicknesses). In this implementation, opaque coloring layer 42 is a titanium carbo-nitride (TiCN) opaque coloring layer. In another implementation, TiCN opaque coloring layer 42 of FIG. 12 may be replaced with a TiN opaque coloring layer, as shown in the example of FIG. 13.

As shown in FIG. 14, thin-film interference filter 38 of coating 36 may include a lowermost layer 104 layered on (contacting) opaque coloring layer 42 and an uppermost layer 102 on layer 104. Layers 102 and 104 may both include SiC (e.g., with different amounts of Si and C between the layers to configure the layers to exhibit different refractive indices). Layer 102 may be thicker (e.g., more than twice as thick) than layer 104. As an example, layer 102 may have a thickness of 50-100 nm, 40-60 nm, 50-70 nm, 30-70 nm, or other thicknesses. Layer 104 may have a thickness of 10-30 nm, 5-35 nm, 15-25 nm, 12-23 nm, or other thicknesses. In this implementation, opaque coloring layer 42 is a CrSiN opaque coloring layer having a thickness greater than the thickness of layers 102 and 104 (e.g., 200 nm or greater). Each of the coatings 36 in FIGS. 5 and 8-14 may exhibit a substantially violet shape that is relatively constant in color response across its surface area despite thickness variations from thickness T2 to thickness T1.

The examples of FIGS. 4-14 are merely illustrative. Additional elements may be included in one or more of the layers of coating 36. The layers may be arranged in other orders. The layers may have different thicknesses or compositions. The coating may have other color profiles and angular responses. The layers described herein may sometimes also be referred to as films.

The foregoing is merely illustrative and various modifications can be made to the described embodiments. The foregoing embodiments may be implemented individually or in any combination.

What is claimed is:

1. Apparatus comprising:
a conductive substrate; and
a coating on the conductive substrate and having a color, the coating comprising:
adhesion and transition layers, and
a thin-film interference filter on the adhesion and transition layers, wherein the thin-film interference filter comprises a SiC layer that forms an uppermost layer of the thin-film interference filter, a SiCrCN layer that forms a lowermost layer of the thin-film interference filter, and a CrC layer interposed between the SiCrCN layer and the SiC layer.

2. The apparatus of claim 1, wherein the coating further comprises:
a CrSiCN layer interposed between the thin-film interference filter and the adhesion and transition layers.

3. The apparatus of claim 2, wherein the CrSiCN layer is opaque.

4. The apparatus of claim 2, wherein the CrSiCN layer is thicker than the thin-film interference filter.

5. The apparatus of claim 2, wherein the adhesion and transition layers comprise:
a seed layer on the conductive substrate, the seed layer comprising CrSiN; and
a transition layer on the seed layer, the transition layer comprising Cr.

6. The apparatus of claim 1, wherein the SiCrCN layer is thicker than the SiC layer and the CrC layer.

7. The apparatus of claim 6, wherein the SiCrCN layer has a thickness between 50 nm and 100 nm.

8. The apparatus of claim 7, wherein the SiC layer has a thickness between 10 nm and 30 nm.

9. The apparatus of claim 1, wherein the coating has an L* value that is greater than 40, an a* value that is greater than −5, and a b* value that is less than −5.

10. The apparatus of claim 1, wherein an atomic percentage of Si atoms in the SiC layer is greater than 20%, an atomic percentage of Cr atoms in the CrC layer is greater than 30%, and an atomic percentage of N atoms in the SiCrCN layer is greater than 30%.

11. Apparatus comprising:
a conductive substrate; and
a coating on the conductive substrate and having a color, the coating comprising:
adhesion and transition layers,
an opaque layer on the adhesion and transition layers, and
a three-layer thin-film interference filter on the opaque layer, the three-layer thin-film interference filter having an uppermost layer comprising SiC.

12. The apparatus of claim 11, wherein the three-layer thin-film interference filter has a lowermost layer comprising SiCrCN and a middle layer comprising CrC.

13. The apparatus of claim 12, wherein the opaque layer comprises CrSiCN.

14. The apparatus of claim 11, wherein the three-layer thin-film interference filter has a lowermost layer comprising SiC and a middle layer comprising CrN.

15. The apparatus of claim 12, wherein the opaque layer comprises CrN.

16. An electronic device comprising:
a conductive structure; and
a coating on the conductive structure and having a color, the coating comprising:
adhesion and transition layers,
an opaque layer on the adhesion and transition layers, and
a two-layer thin-film interference filter on the opaque layer.

17. The electronic device of claim 16, wherein the two-layer thin-film interference filter comprises a first CrC layer and a second CrC layer on the first CrC layer and wherein the opaque layer comprises a TiN layer or a TiCN layer.

18. The electronic device of claim 16, wherein the two-layer interference filter comprises an uppermost TiSiCN layer and a lowermost CrSi layer.

19. The electronic device of claim 16, wherein the two-layer interference filter comprises an uppermost SiC layer and a lowermost CrC layer.

20. The electronic device of claim 16, wherein the two-layer interference filter comprises a lowermost TiSiCN layer.
